(19) United States
(12) Patent Application Publication
(10) Pub. No.: US 2012/0261427 A1
(43) Pub. Date: Oct. 18, 2012

(54) Insulated Container with Debossed Overwrap

(76) Inventor: Aaron L. Bates, Moseley, VA (US)

(21) Appl. No.: 13/085,163

(22) Filed: Apr. 12, 2011

(51) Int. Cl. B65D 81/38; B65D 85/00; B23P 11/00; A47J 41/00

(52) U.S. Cl. 220/592.17; 220/592.2; 206/459.5; 29/428

(57) ABSTRACT

An insulated container including a base container having a side wall that defines an internal volume and an opening into the internal volume and an overwrap positioned over the side wall, the overwrap including bosses extending inward toward the base container, wherein the bosses are configured as indicia.

### FIELD

This application relates to containers and, more particularly, to insulated containers, such as insulated beverage cups.

### BACKGROUND

Beverage cups are widely used to hold both hot and cold beverages. Examples of hot beverages commonly served in beverage cups include coffee and tea. Examples of cold beverages commonly served in beverage cups include soda and water, which are served either with or without ice.

Unfortunately, hot beverages rapidly cool once placed in a typical beverage cup. The use of a tight-fitting lid may inhibit cooling. However, a significant portion of the cooling is typically effected by heat transfer from the hot beverage, across the walls of the container and, ultimately, to the ambient atmosphere.

Heat transfer across the walls of beverage containers has an opposite effect on cold beverages. Specifically, cold beverages warm over time, which may result in melting of the ice and, thus, unintentional dilution of the beverage. Furthermore, in humid environments, water droplets (i.e., condensation) tend to form on the external surface of poorly insulated beverage containers housing cold beverages. Such condensation may pool over time.

Rapid cooling of hot beverages and warming of cold beverages, as well as the pooling of condensation, have been cited as reasons for customer dissatisfaction. Therefore, efforts have been made to insulate the walls of beverage containers. Unfortunately, efforts to insulate the walls of beverage containers have encountered various obstacles. For example, polystyrene foam beverage containers provide improved insulation, but tend to be fragile and are not biodegradable. Environmentally friendly beverage containers tend to provide only limited insulation.

Accordingly, those skilled in the art continue with research and development efforts in the field of insulated containers.

### SUMMARY

In one aspect, the disclosed insulated container may include a base container having a side wall that defines an internal volume and an opening into the internal volume, and an overwrap positioned over the side wall, the overwrap including bosses extending inward toward the base container, wherein the bosses are configured as indicia.

In another aspect, the disclosed insulated container may include a base container having a side wall that defines an internal volume and an opening into the internal volume, and an overwrap positioned over the side wall, the overwrap including a plurality of bosses extending inward toward the base container, wherein the plurality of bosses are configured as indicia, and a plurality of texturing bosses extending away from the base container.

In another aspect, disclosed is a method for forming a container. The method may include the steps of (1) providing a base container having a side wall that defines an internal volume and an opening into the internal volume, (2) providing an overwrap having indicia debossed therein and (3) applying the overwrap to the side wall of the base container such that the debossed indicia extends toward the side wall.

In yet another aspect, disclosed is a method for forming a container. The method may include the steps of (1) providing a base container having a side wall that defines an internal volume and an opening into the internal volume, (2) providing an overwrap, (3) debossing the overwrap to form indicia therein and (4) applying the overwrap to the side wall of the base container such that the debossed indicia extends toward the side wall.

Other aspects of the disclosed insulated container with debossed overwrap and methods for forming the same will become apparent from the following description, the accompanying drawings and the appended claims.

### BRIEF DESCRIPTION OF THE DRAWINGS

FIG. 1 is a front elevational view of one aspect of the disclosed insulated container with debossed overwrap;

FIG. 2 is a front elevational view, in section, of the insulated container of FIG. 1;

FIG. 3 is a front elevational view of the base container of the insulated container of FIG. 1;

FIG. 4 is a top plan view of the overwrap of the insulated container of FIG. 1, shown prior to being applied to the base container of FIG. 3; and

FIG. 5 is a side elevational view, in section, of the overwrap of FIG. 4.

### DETAILED DESCRIPTION

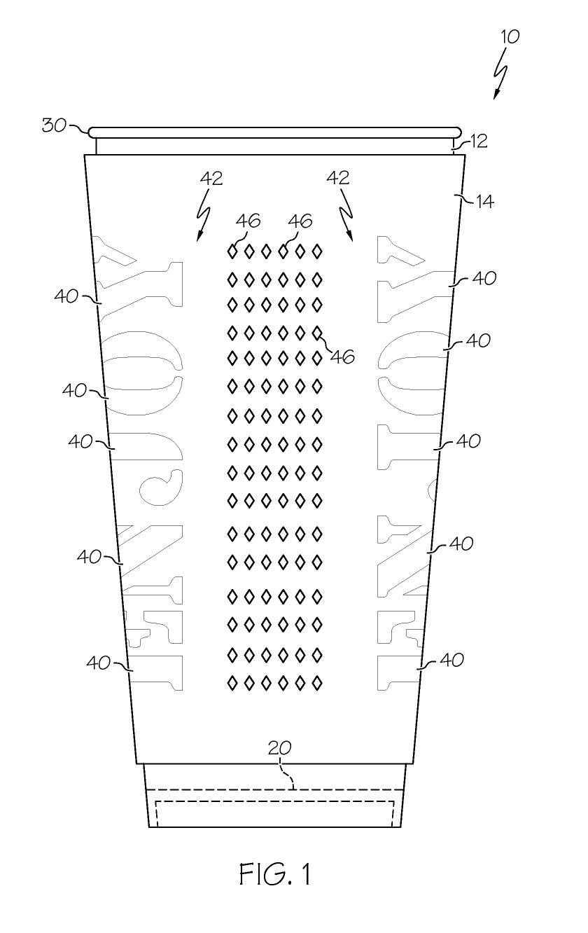

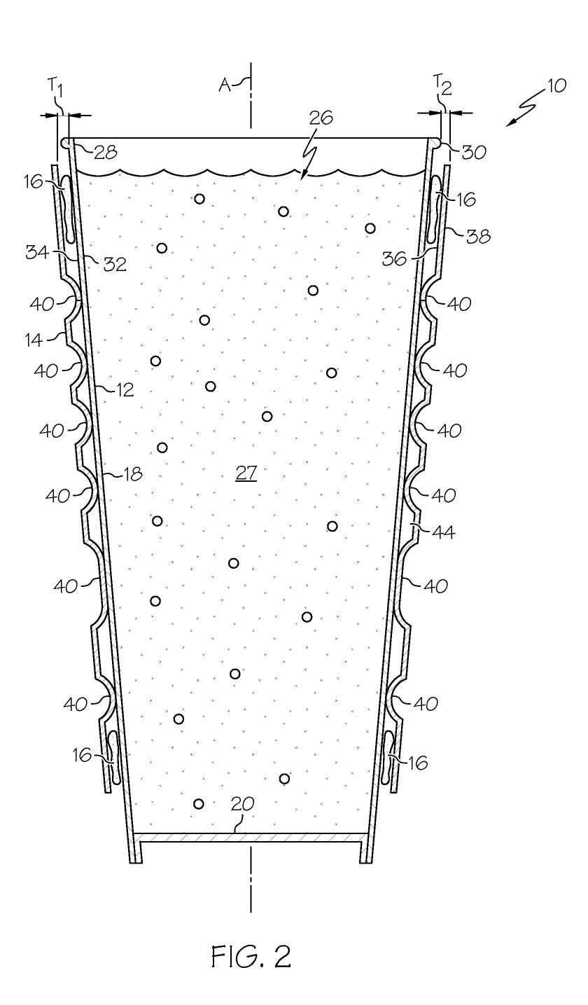

Referring to FIGS. 1 and 2, one aspect of the disclosed insulated container, generally designated 10, may be formed as a double wall beverage cup, such as a 12-ounce, 16-ounce or 24-ounce disposable beverage cup. While the insulated container 10 is shown in FIGS. 1 and 2 as having a generally frustoconical shape, those skilled in the art will appreciate that containers of various shapes and sizes may be constructed without departing from the scope of the present disclosure.

The insulated container 10 may include a base container 12 and an overwrap 14. An adhesive 16 may be positioned between the base container 12 and the overwrap 14 to connect the overwrap 14 to the base container 12. Other techniques for securing the overwrap 14 to the base container 12, such as use of mechanical fasteners, heat sealing or an interference fit, are also contemplated.

Thus, as shown in FIG. 2, the insulated container 10 may be formed as a layered structure that includes a base container layer 12, an overwrap layer 14 and, optionally, an adhesive layer 16. Additional layers, such as additional adhesive layers and additional overwrap layers, may be included without departing from the scope of the present disclosure.

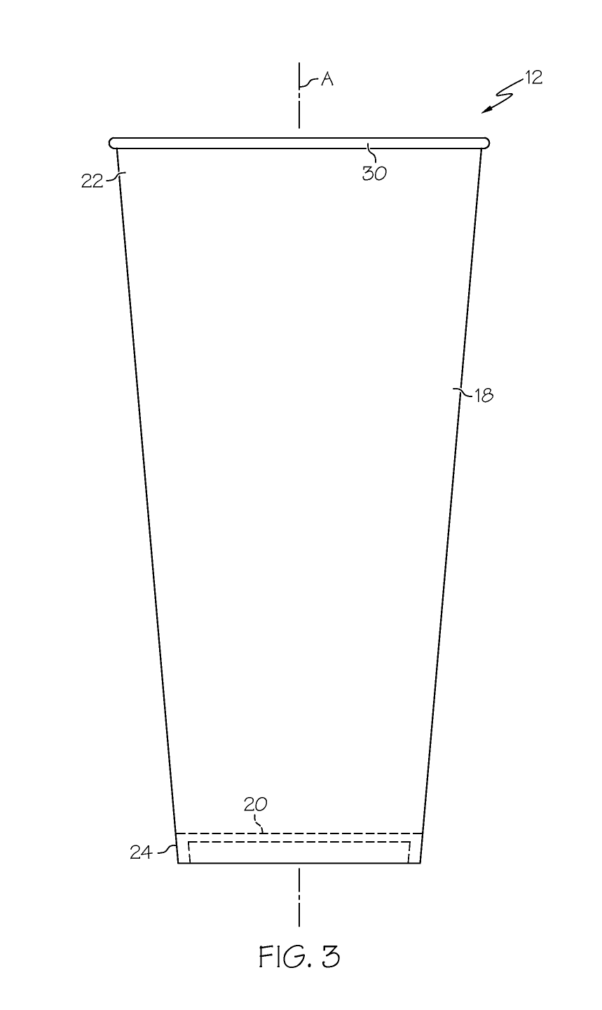

Referring to FIG. 3, the base container 12 may include a side wall 18 and a base wall 20. The side wall 18 of the base container 12 may include an upper end portion 22 and a lower end portion 24, and may extend circumferentially about a longitudinal axis A to define an internal volume 26 (FIG. 2). The base wall 20 may be connected to the lower end portion 24 of the side wall 18 to partially enclose the internal volume 26. The upper end portion 22 of the side wall 18 may define an opening 28 (FIG. 2) into the internal volume 26 (FIG. 2).

Optionally, the upper end portion 22 of the side wall 18 of the base container 12 may include a circumferential rim 30. The rim 30 may be formed by outwardly rolling the upper end portion 22 of the side wall 18. Those skilled in the art will appreciate that the rim 30 may provide structure to which a lid (not shown) may be releasably connected to seal the opening 28 (FIG. 2) into the internal volume 26.

As shown in FIG. 2, the side wall 18 of the base container 12 may include an inner surface 32 and an outer surface 34, and may have a cross-sectional thickness T₁. Optionally, the inner surface 32 of the side wall 18 may be coated with a moisture barrier material, thereby rendering the side wall 18 resistant to moisture penetration when the internal volume 26 is filled with a product 27, such as a beverage or a foodstuff. For example, the moisture barrier material may be (or may include) a layer of polyethylene that has been laminated, extrusion coated or otherwise connected (e.g., with adhesives) to the inner surface 32 of the side wall 18.

In a first expression, the base container 12 may be a paperboard container. For example, the base container 12 may be formed by shaping a paperboard blank on a cup forming machine, such as the PMC 1002 cup/container machine available from Paper Machinery Corporation of Milwaukee, Wis. The paperboard blank may have a cross-sectional thickness T₁ of at least about 6 points, such as about 8 to about 24 points, wherein 1 point equals 0.001 inch.

In a second expression, the base container 12 may be a polymeric container. As one example of the second expression, the base container 12 may be formed by shaping a polymeric blank, such as polycarbonate or polyethylene terephthalate blank, on a cup forming machine, such as the PMC 1002P container machine available from Paper Machinery Corporation. As another example of the second expression, the base container 12 may be formed by vacuum molding, extrusion molding, injection molding or thermoforming a polymeric material, such as polycarbonate, polyethylene terephthalate or polystyrene.

At this point, those skilled in the art will appreciate that the base container 12 may be formed from various materials using various techniques, and may be configured in various shapes and sizes, without departing from the scope of the present disclosure.

The adhesive 16 may be positioned between the overwrap 14 and the base container 12 to connect the overwrap 14 to the base container 12. Various adhesives 16, including water-based adhesive (e.g., latex adhesives) and organic solvent-based adhesive, may be used to connect the overwrap 14 to the base container 12.

In one particular implementation, the adhesive 16 may be a thermally insulating adhesive. In one specific example, the thermally insulating adhesive 16 may be formulated to include styrene-butadiene or acrylic SRB latex (binder), wood flour (organic filler), AeroWhip® (foam stabilizer available from Ashland Aqualon Functional Ingredients of Wilmington, Del.), corn fibers (organic filler), calcium carbonate (inorganic filler) and starch (binder), wherein the components of the thermally insulating adhesive have been mechanically whipped together to form a foam. Other examples of suitable thermally insulating adhesives are described in greater detail in U.S. Ser. No. 61/287,990 filed on Dec. 18, 2009, the entire contents of which are incorporated herein by reference.

The overwrap 14 may circumferentially extend about the side wall 18 of the base container 12. As best shown in FIG. 1, the overwrap 14 may have an overall surface area that is less than the overall surface area of the side wall 18 base container 12. Therefore, the overwrap 14 may cover only a portion of the side wall 18 of the base container 12. As one example, the overwrap 14 may cover at least 60 percent of the side wall of the base container 12. As another example, the overwrap 41 may cover at least 80 percent of the side wall of the base container 12. As yet another example, the overwrap 14 may cover at least 90 percent of the side wall of the base container 12.

As shown in FIG. 2, the overwrap 14 may include an inner surface 36 and an outer surface 38, and may have a cross-sectional thickness T₂. The adhesive 16 may connect the inner surface 36 of the overwrap 14 to the outer surface 34 of the base container 12.

In one particular construction, the overwrap 14 may be formed from paperboard. The paperboard may be bleached or unbleached, and may have a basis weight of at least about 85 pounds per 3000 square feet and a cross-sectional thickness T₂ of at least about 6 points. For example, the overwrap 14 may be formed from paperboard, such as linerboard or solid bleached sulfate (SBS), having a basis weight ranging from about 180 to about 270 pounds per 3000 square feet and a thickness T₂ ranging from about 12 to 36 points.

Optionally, the paperboard used to form the overwrap 14 may include various components and optional additives in addition to cellulosic fibers. For example, the paperboard used to form the overwrap 14 may optionally include one or more of the following: binders, fillers (e.g., ground wood particles), organic pigments, inorganic pigments, hollow plastic pigments, expandable microspheres and bulking agents, such as chemical bulking agents.

Overwraps 14 formed from materials other than paperboard, such as polymeric materials, are also contemplated.

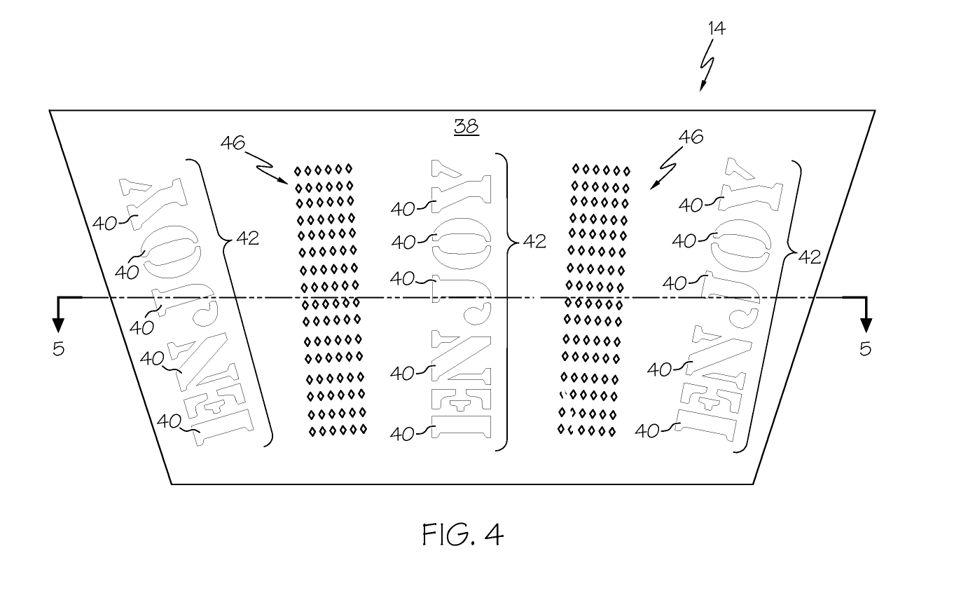

As shown in FIG. 4, the overwrap 14 may be formed by die-cutting a sheet of stock material, such as paperboard, to produce an overwrap blank. The trapezoidal, keystone shape of the overwrap blank 14 shown in FIG. 4 may allow the overwrap 14 to closely correspond to the frustoconical shape of the base container 12, as shown in FIGS. 1 and 2.

The overwrap blank 14 may be wrapped onto the base container 12 to form the layered structure of the insulated container 10. Alternatively, the overwrap blank 14 may first be assembled into a sleeve, and then the sleeve may be positioned over the base container 12 to form the layered structure of the insulated container 10.

In one specific, non-limiting example, the disclosed insulated container 10 may be formed from a paperboard-based base container 12 and a paperboard-based overwrap 14. A latex based adhesive 16 may connect the paperboard-based overwrap 14 to the paperboard-based base container 12. Therefore, the resulting insulated container 10 may be substantially biodegradable.

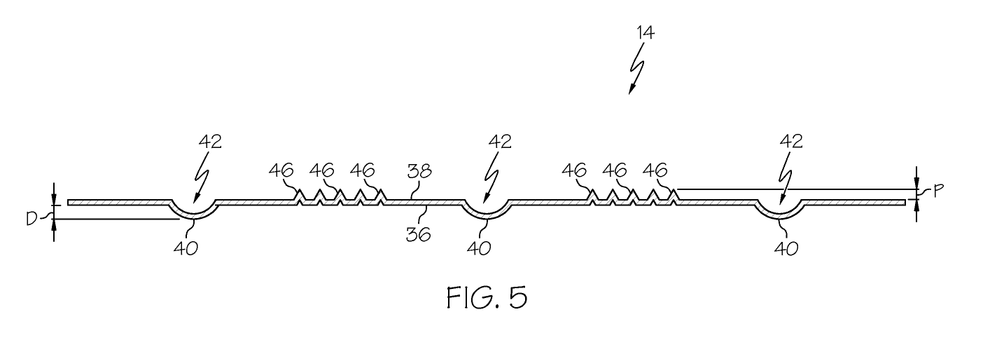

Referring to FIGS. 1 and 4, the overwrap 14 may include a plurality of bosses 40 configured as indicia 42. As shown in FIGS. 2 and 5, the bosses 40 may be recessed into the outer surface 38 of the overwrap 14 and may extend radially inward into abutting engagement with the base container 12.

The bosses 40 may be formed by debossing the overwrap 14 prior to applying the overwrap 14 to the base container 12. For example, the bosses 40 may be formed by passing a sheet of paperboard through an embossing/debossing press to form the bosses 40, die-cutting the debossed paperboard to form the overwrap blank 14 (FIG. 4), and applying the debossed overwrap blank 14 to the base container 12 such that the bosses 40 extend radially inward toward the base container 12.

As shown in FIG. 5, each boss 40 may have a depth D. As one example, the depth D of each boss 40 may be at least 6 points. As another example, the depth D of each boss 40 may range from about 10 to about 25 points.

Thus, in addition to defining indicia 42, the bosses 40 may also function as spacers that space the overwrap 14 from the base container 12 by a distance corresponding to the depth D of the bosses 40. The spacing between the overwrap 14 and the base container 12 may define an annular region 44 between the overwrap 14 and the base container 12 that insulates the insulated container 10. The adhesive 16 may be positioned in the annular region 44 to connect the overwrap 14 to the base container 12. Portions of the annular region 44 not filled with the adhesive 16 may be filled with ambient air.

The indicia 42 defined by the bosses 40 may be in the form of various letters (e.g., “ENJOY”), numbers, images (e.g., logos) or a combination of letters, numbers and/or images. In one particular implementation, the indicia 42 defined by the bosses 40 may be identifying indicia, such as images or text (e.g., “SODA”) identifying the contents of the insulated container 10 or images or text (e.g., “COCA-COLA”) identifying the source of the contents of the insulated container 10.

Referring back to FIGS. 1 and 4, the overwrap 14 may further include a plurality of texturing bosses 46. As shown in FIGS. 2 and 5, the texturing bosses 46 may radiate outward from the outer surface 38 of the overwrap 14 (i.e., away from the base container 12).

The texturing bosses 46 may be formed by embossing the overwrap 14 prior to applying the overwrap 14 to the base container 12. For example, the texturing bosses 46 may be formed by embossing the overwrap blank 14 (FIG. 4) at the same time the overwrap blank 14 is debossed to form the bosses 40.

As shown in FIG. 5, each texturing boss 46 may protrude a distance P from the outer surface 38 of the overwrap 14. As one example, the protruding distance P of each texturing boss 46 may be at least 2 points. As another example, the protruding distance P of each texturing boss 46 may range from about 4 to about 10 points.

The texturing bosses 46 may have a surface area (in plan view) ranging from about 1 to about 50 mm². For example, as shown in FIG. 4, the texturing bosses 46 may be diamond-shaped in plan view and may have a width of about 4 mm and a length of about 6 mm. Therefore, the texturing bosses 46 may have a surface area of about 12 mm². While the texturing bosses 46 are shown as being diamond-shaped in plan view, those skilled in the art will appreciate that texturing bosses 46 of various shapes (in plan view), such as circular, square, oblong, star or irregular, may be used without departing from the scope of the present disclosure.

The texturing bosses 46 may be arranged on the overwrap 14 in various ways. For example, as shown in FIG. 4, the texturing bosses 46 may be arranged in blocks comprised of multiple rows of texturing bosses 46. However, those skilled in the art will appreciate that the texturing bosses 46 may be arranged in various patterns or may be randomly arranged.

Thus, the texturing bosses 46 may provide surface texture to the overwrap 14 to improve grip. Furthermore, the texturing bosses 46 may increase the volume of the annular region 44 (FIG. 2) to improve insulation.

Accordingly, the disclosed insulated container 10 may include an overwrap 14 positioned over a base container 12. The overwrap 14 may be debossed to provide a plurality of inwardly extending bosses 40 configured as indicia 42, such as identifying indicia, wherein the bosses 40 also function to space the overwrap 14 from the base container 12. Additionally, the overwrap 14 may be embossed to provide a plurality of outwardly extending texturing bosses 46, wherein the texturing bosses 46 provide the overwrap 14 with texture that promotes gripping of the insulated container 10 and increase the volume of the annular region 44 to increase the insulating effect of the annular region 44.

Although various aspects of the disclosed insulated container with debossed overwrap have been shown and described, modifications may occur to those skilled in the art upon reading the specification. The present application includes such modifications and is limited only by the scope of the claims.

What is claimed is:

1. A container comprising:
a base container comprising a side wall that defines an internal volume and an opening into said internal volume; and
an overwrap positioned over said side wall, said overwrap comprising a plurality of bosses extending inward toward said base container, wherein said plurality of bosses are configured as indicia.

2. The container of claim 1 wherein said indicia comprises identifying indicia.

3. The container of claim 1 further comprising a product positioned in said internal volume, wherein said indicia is indicative of said product.

4. The container of claim 1 wherein said base container is shaped as a generally frustoconical cup.

5. The container of claim 1 wherein said base container comprises a rim extending about said opening.

6. The container of claim 1 wherein said base container comprises an inner surface and an outer surface, and wherein at least one of said inner surface and said outer surface is coated with a moisture barrier material.

7. The container of claim 1 wherein said base container comprises paperboard.

8. The container of claim 1 further comprising an adhesive positioned between said base container and said overwrap.

9. The container of claim 8 wherein said adhesive is a foam.

10. The container of claim 1 wherein said side wall has a first surface area and said overwrap has a second surface area, and wherein said second surface area is at least 60 percent of said first surface area.

11. The container of claim 1 wherein said overwrap comprises paperboard.

12. The container of claim 11 wherein said overwrap has a basis weight of at least 85 pounds per 3000 square feet.

13. The container of claim 1 wherein each boss of said plurality of bosses has a depth of at least 6 points.

14. The container of claim 1 wherein said plurality of bosses extend into abutting engagement with said base container.

15. The container of claim 1 wherein said overwrap further comprises a plurality of texturing bosses extending away from said base container.

16. The container of claim 15 wherein said plurality of texturing bosses are arranged in a pattern.

17. The container of claim 15 wherein each texturing boss of said plurality of texturing bosses has a surface area, in plan view, ranging from about 1 to about 50 mm².

18. A container comprising:
a base container comprising a side wall that defines an internal volume and an opening into said internal volume; and
an overwrap positioned over said side wall, said overwrap comprising:
a plurality of bosses extending inward toward said base container, wherein said plurality of bosses are configured as indicia; and
a plurality of texturing bosses extending away from said base container.

19. A method for forming a container comprising the steps of:
providing a base container comprising a side wall that defines an internal volume and an opening into said internal volume;
providing an overwrap comprising indicia debossed into said overwrap; and
applying said overwrap to said side wall of said base container such that said debossed indicia extends toward said side wall.

20. The method of claim 19 wherein said overwrap further comprises texturing bosses embossed into said overwrap.
